(19) United States
(12) Patent Application Publication
(10) Pub. No.: US 2006/0088647 A1
(43) Pub. Date: Apr. 27, 2006

(54) Baked products containing rice flour

(76) Inventor: Ranjit S. Kadan, New Orleans, LA (US)

Correspondence Address: USDA, ARS, OTT, 5601 SUNNYSIDE AVE, RM 4-1159, BELTSVILLE, MD, 20705-5131, US

(21) Appl. No.: 10/972,707

(22) Filed: Oct. 25, 2004

(51) Int. Cl. A21D 2/00

(52) U.S. Cl. 426/622

(57) ABSTRACT

A mix for the preparation of rice-containing baked products, containing 100% rice flour (containing about 15 to about 26% amylose), about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt. A method for preparing a rice-containing baked product, involving mixing 100% rice flour (containing about 15 to about 26% amylose), about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt with an amount of water and oil and for a time sufficient to wet all the particles, and baking.

### BACKGROUND OF THE INVENTION

The present invention relates to a mix for the preparation of rice-containing baked products, containing 100% rice flour (containing about 15 to about 26% amylose), about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt. In addition, the present invention concerns a method for preparing a rice-containing baked product, involving mixing 100% rice flour (containing about 15 to about 26% amylose), about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt with an amount of water and oil and for a time sufficient to wet all the particles, and baking; wherein the rice-containing baked product is free of wheat.

Bakery products are commonly made from wheat flour containing gluten which contributes to the typical texture, flavor and form of the usual bread and cake products. There are however circumstances in which wheat flour cannot be used for the production of baked products. For example, a segment of the population suffers from dietary wheat intolerance or toxicity which includes classical Celiac disease and related, less well defined wheat intolerances and allergies and toxicities all expressed by gastrointestinal disturbances, which makes wheat based products unacceptable for use by this segment of the population. It is estimated that 1 in 200 people suffer from Celiac disease in the United States. People suffering from Celiac disease cannot consume foods containing wheat, rye, and barley since certain prolamine proteins (e.g., gliadin in wheat, seculin in rye, and hordein in barley) are detrimental to them even in very small quantities.

Thus it is desirable to develop bread, crackers, pretzels, cookies, and cake type products which are not based on wheat. However the development of a wide range of such products has been prevented because of the critical role attributed to gluten in the baking process. It is a generally accepted view that the outstanding suitability of wheat flour to yield light, evenly structured baked products with a soft crumb from doughs simply made with water and yeast is due mainly to the wheat flour proteins (e.g., gliadin) that complex with another protein called glutenin in aqueous condition to make gluten which is essential to breads and other baked foods.

Rice has characteristics such as the absence of gluten, low levels of sodium, protein, fat, and fiber; and a high level of easily digested carbohydrates which make it desirable for certain special diets. Baked products prepared with significant quantities of rice flour provide an important dietary addition to persons with wheat or gluten allergies, hypertension, nephritis, or digestive difficulties. However, it is a challenge to make, for example, rice bread since rice does not have any gliadin and thus no gluten. Furthermore, the availability of baked products containing significant amounts of rice flour in place of wheat flour has been limited due to the difficulty of obtaining products which are acceptable to consumers.

### SUMMARY OF THE INVENTION

In accordance with the present invention there is provided a mix for the preparation of rice-containing baked products, containing 100% rice flour (containing about 15 to about 26% amylose), about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt.

Also in accordance with the present invention, there is provided a method for preparing a rice-containing baked product, involving mixing 100% rice flour (containing about 15 to about 26% amylose), about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt with an amount of water and oil and for a time sufficient to wet all the particles, and baking.

### BRIEF DESCRIPTION OF THE DRAWINGS

FIG. 1 shows breads of the present invention and commercial breads as described below.

### DETAILED DESCRIPTION OF THE INVENTION

The present invention concerns a mix for the preparation of rice-containing baked products, containing 100% rice flour (containing about 15 to about 26% amylose), about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt. Furthermore, the present invention relates to a method for preparing a rice-containing baked product, involving mixing 100% rice flour (containing about 15 to about 26% amylose), about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt with an amount of water and oil and for a time sufficient to wet all the particles, and baking. Generally, the rice-containing baked product is free of wheat.

The present invention allows one to make a baked product (e.g., bread, cakes, muffins, cupcakes, crackers, pretzels, cookies, and the like) from rice by using a commonly available bread machine or regular oven. Specifically, it allows one to make rice bread by using rice flour (e.g., short or medium or long grain rice flour, for example long grain rice flour containing about 15-26% amylose; generally made from broken rice which is a lower price rice and a by-product of rice milling) and other ingredients described herein. The rice bread is uniquely suited for people suffering from Celiac disease since rice proteins are devoid of gliadin, secalin, and hordein protein moieties found in wheat, rye, and barley respectively. The rice bread may also benefit people suffering from food allergies, chronic fatigue syndrome, and other health conscious consumers. About 50% of Celiacs are also allergic to other foods (e.g., eggs, soybean, and milk) and it is fortunate that rice grain is a very hypoallergenic food. Another advantage is that rice bread can be conveniently made so consumers can make their own rice bread in their homes and consume it fresh, thus avoiding undesirable staling of commercial products. The present invention makes it possible for consumers to make rice bread at a fraction of the cost of commercial rice bread. The consumers can also add other ingredients if they are not allergic to those additional ingredients. Generally, the breads of the present invention have the following characteristics: specific volume is generally up to about 4.5 and >about 2.5 (e.g., >2.5), preferably >about 3 (e.g., >3), more preferably >about 3.5 (e.g., >3.5), most preferably between about 3.5-about 4.3 (e.g., 3.5-4.3); hardness is generally above 0 and <about 1 (e.g., <1), preferably <about 0.75 (e.g., <0.75), more preferably <about 0.5 (e.g., <0.5); springiness is generally above 0 and <about 1.1; cohesiveness is generally above 0 and <about 0.7; gumminess is generally above 0 and <about 0.6 (e.g., <0.6), preferably <about 0.5 (e.g., <0.5), more preferably <about 0.3 (e.g., <0.3); chewiness is generally above 0 and <about 0.5 (e.g., <0.5), preferably <about 0.4 (e.g., <0.4), more preferably <about 0.35 (e.g., <0.35); and resilence is generally above 0 and <about 0.4.

The prior art limited the amount of water added in rice bread mix to 75% (baker's percentage) or about actual 38% (Hall, J. R., Use of Rice and its Rice Derivatives in Bakery Products. Technical Bulletin # XVIII, Isuue 3, March 1996; Nishita K. D., et al., Cereal Chem., 53(5):626-635 (1976); Nishita, K. D., and M. M. Bean, Cereal Chem., 56(3): 185-189 (1979)). I have discovered a new method to make rice bread which uses higher amounts of water (preferably 110% vs 75% -baker's or 46% vs 38% actual) than the prior art. The baking method is also very different.

Using baker's percentages (where an arbitrarily value of 100% is assigned to the flour and the other ingredients are calculated as percentages of flour), the composition to make bread may contain the following:

Rice flour: 100% (containing about 15% to about 26% amylose, preferably more than about 20% (e.g., more than 20%, more than 20% up to about 26%)). The starch is made of either amylose (straight chain) or amylopectin (branched chain); for example, if starch has 18% amylose then it also has 82% amylopectin. The rice flour preferably has little damage to its starch moiety (Kelloplex (pin mill to grind) is a good example), and the majority of particle sizes range between about 100 to about 150 mesh (about 100 to about 150 μ; thus there will be some particles less than 100 μ or more than 150 μ in the milled flour). Rice flour useful in the instant invention is the product obtained from the milling of short or medium or long grain rices grown in the United States or the equivalent thereof.

Waxy rice flour: about 0 to about 20% (e.g., 0-20%), preferably no waxy rice flour. Waxy rice flour may impart softer texture, if it is needed, although it decreases the specific volume.

Yeast: about 1 to about 5% (e.g., 1-5%), preferably about 1.5 to about 2.2% (e.g., 1.5-2.2%). More than about 5% is not recommended since higher amounts decrease the specific volume as it makes more CO₂ and the gas and steam escape during baking. Generally Fleishmann's Bread Machine yeast (distributed by Bums Foods Inc., Fenton, Mo.) may be used.

Rice bran: about 0 to about 10% (e.g., 0-10%), preferably about 2 to about 7% (e.g., 2-7%). More than about 10% is not recommended since higher amounts decrease specific volume and increase hardness. The rice bran is rich in nutraceuticals and fiber which can lower cholesterol and improve blood sugar levels. Defatted, milled rice bran (100-200 mesh; Riceland Foods, Inc. Stuttgart, Ark.) or stabilized full fat bran may be used; preferably defatted rice bran is used.

Sugar: about 4 to about 20% (e.g., 4-20%), preferably about 12% (e.g., 12%). The sugar may be cane sugars obtained from a local grocery store or other sugars such as corn syrup sugar and fructose sugars. Generally any sugar may be used which is fit for human consumption and which provides food for yeast to grow. Sugar contributes to the flavor by enhancing ‘browning reaction’ and other flavors.

Oil: about 2 to about 15% (e.g., 2-15%), preferably about 6% (e.g., 6%). More than about 15% is not recommended since higher amounts of oils makes bread collapse though it imparts softer and less crumbly texture. Preferably the oil is rice bran oil (e.g., a minimum refined rice bran oil which may be obtained from Oilseeds International Ltd., a division of Riceland Foods, Inc.). Rice bran oil is very high in mono- and polyunsaturated fatty acids, it is also rich in natural antioxidents and therefore very stable in baking and frying. Other oils which may be used include peanut oil, canola oil, olive oil, and shortening (e.g., CRISCO). Rice bran oil gave the best breads when compared to breads using other oils (identical concentrations); other liquid oils made the bread collapse during final stages of baking and CRISCO decreased the specific volume by almost 50%. It may be possible to make good quality rice bread using non-rice bran liquid oils by adjusting their levels and/or modifying bread making techniques.

Hydroxypropyl methylcellulose food gums: about 1 to about 4% (e.g., 1-4%), preferably about 2% (e.g., 2%). The hydroxypropyl methylcelluloses (e.g., METHOCEL) food gums which may be used in the present invention are described in A Food Technologist's Guide to METHOCEL Food Gums by Dow and also in U.S. Pat. No. 5,009,895. Celluloses are linear polymers of anhydroglucose, and hydroxypropyl methylcellulose, also referred to herein as “HPMC,” is an anhydroglucose in which some of the hydroxyl groups are substituted with methyl groups to form methyl ether moieties, and others are substituted with hydroxypropyl groups or with methoxypropyl groups to form hydroxypropyl ether or methoxypropyl ether moieties. Examples of hydroxypropyl methylcelluloses that are commercially available are METHOCEL E (USP type 2910), METHOCEL F (USP type 2906), METHOCEL J (USP type 1828), METHOCEL K (USP type 2201), and METHOCEL 310 Series, products of The Dow Chemical Company, Midland, Mich., USA, the different products varying slightly in the degree of methoxyl and hydroxypropyl substitution. The average degree of methoxyl substitution in these products ranges from about 1.3 to about 1.9 (of the three positions on each unit of the cellulose polymer that are available for substitution) while the average degree of hydroxypropyl substitution per unit expressed in molar terms ranges from about 0.13 to about 0.82. In the present invention it is preferred to use METHOCEL K4M.

Salt: about 1 to about 4% (e.g., 1-4%), preferably about 2.6% (e.g., 2.6%).

Water: about 80 to about 130% (e.g., 80-130%), preferably about 110% (e.g., 110%). More than 130% is not recommended since higher amounts makes the bread too soft.

More specifically the present invention provides a mix for the preparation of baked products comprising rice flour (e.g., short or medium or long grain rice flour, for example long grain rice flour containing more than about 20% amylose), hydroxypropyl methylcellulose (e.g., METHOCEL) food gum, baker's yeast, sugar (e.g., sucrose), and salt; wherein said products are produced in the substantial absence of wheat flour. Thus mixes according to the present invention preferably will comprise (using baker's percentages) the following: 100% rice flour, about 0 to about 20% (preferably 0%) waxy rice flour, about 1 to about 4% (preferably about 2%) hydroxypropyl methylcellulose food gums, about 1 to about 5% (preferably about 1.5 to about 2.2%) yeast, about 0 to about 10% (preferably about 2 to about 7%) rice bran, about 4 to about 20% (preferably 12%) sugar, and about 1 to about 4% (preferably about 2.6%) salt. The mix of the present invention can be formed into a dough by combining the mix with oil (e.g., rice bran oil) and water. The amount of water used should be that quantity sufficient to make the dough. Unlike the methods described in U.S. Pat. No. 4,508,736, the methods of the present invention do not require a holding time for a mixture of the rice flour and water (prior to addition of other ingredients such as sugar and oil) in order to hydrate the rice flour. Thus the rice flour does not have to be hydrated prior to the addition of the other ingredients; preferably the rice flour is not hydrated prior to the addition of the other ingredients.

Generally, the rice bread is made by mixing the dry ingredients in a container, adding water and oil into the pan of the bread machine and then adding the mixed dry ingredients into the pan (or vice versa). The bread machine may be programmed as follows:

First Kneading—about 5 min to about 2 hrs (e.g., 5 min-2 hrs) depending upon the temperature of storage (longer at room temperature, about 75° F.) or refrigerated temperatures about 45-about 60° F.). The temperature can be about 45-about 90° F. (e.g., 45-90° F.). For example, about 10 min at about 90° F. In the example below 10 min at about 90° F. means the temperature of the mixture reached 90° F. from room temperature.

First Rise—about 2-about 30 min (e.g., 2-30 min) depending upon the desired baked product. For example, about 5 min at about 90° F.

Second Kneading—about 2-about 30 minutes (e.g., 2-30 min). It is understood if one hand kneaded, time can be very low (about 2 min) and temperature of the dough will fall closer to room temperature. In the bread machine about 20 min at about 90° F. works fine.

Second Rise—about 10-about 60 min (e.g., 10-60 min) at about 90°-about 140° F. (e.g., 90°-140° F.) depending upon the desired baked product.

Punch/rest—about 30 sec to about 15 min. (e.g., 30 sec-15 min); for example about 30 sec at about 140° F. Obviously the temperature will drop if the dough is taken out of the container closer to room temp. Punch/rest (some baking books call it knocked-back) involves a brief mixing in order to bring about more vigorous fermentation or gas production by bringing yeast into additional contact with the sugar initially added to the mixture, to drive out stale gas and re-establish an even temperature throughout the dough; it can be done by hand or by mechanical mixing.

Third Rise (final)—about 30-about 90 min. (e.g., 30-90 min); for example, about 55 min at about 140°-150° F.

Bake—about 30 -about 90 min (e.g., 30-90 min) depending upon the baking oven temperature; for example, about 50 min at about 150°-357° F.

Using the above-mentioned primary ingredients various mixes for cakes and bread-type products can be prepared with the addition of other standard ingredients known per se in the art and the choice and grade of said other ingredients in a complete mix are not critically related to the invention and may follow standard practice in the art.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

The composition to make rice bread contained the following:

233 g rice flour (having majority of particles between 100-150 microns),

11.7 g rice bran (having majority of particles between 100-150 microns),

5.1 g baker's yeast,

30 g sucrose,

14 g rice bran oil,

4.7 g Methocel (K4M), and

6 g salt.

The dry ingredients were mixed in a container. Water (256 g) and rice bran oil (14 g) were added into the pan of the bread machine and then the mixed dry ingredients were added into the pan. The bread machine was programmed as follows:

Kneading (1^{st})—10 min at about 90° F.,

Rise (1^{st})—5 min at about 90° F.,

Kneading (2^{nd})—20 min at about 90° F.,

Rise (2^{nd})—30 min at about 90-140° F.,

Punch /Rest—30 sec at about 140° F.,

Rise (final)—55 min at about 140-150° F.,

Bake—50 min at about 150-357° F.

The rice bread had texture parameters such as hardness, fracturability, springiness, cohesiveness, gumminess, chewiness and resilience, as measured by an instrument, comparable to wheat bread. The specific volume (ml/g) of 4-5 was also comparable to wheat bread.

Table 1 compares examples of the breads of the present invention with commercial breads for the following characteristics:

Texture Profile Analysis (TPA): The TPA was conducted on one day old bread samples by using a TA-XT2 (Texture Technologies Corp., Scardale, N.Y.) texture analyzer, using a 7 mm circular probe. A 1.4 cm thick slice was removed from the edge of the side of the bread containing the crust. Then three more one cm thick slices were cut. One cm of the edges of the bread was removed from all sides and texture determined. The texture analyzer's settings were as follows: pre-test speed, 2 mm/s; post test speed 1 mm/s; rupture test distance 1%; distance 30% strain; force 0.020 kg; and contact area 230 mm². The above procedure was repeated for each determination. Real-time data acquisition was accomplished by following the user's guide of the TA-XT2. The soft ware was used to calculate hardness (kg), fracturability (kg), springiness, cohesiveness, chewiness and resilience values (Boume, M.C., Principles of objective texture measurements, In: Boume Mc, editor, Food texture and viscosity: concept and measurements, New York, Academic Press, p 44-117 (1982)). The TPA values reported are the averages of 3 different determinations.

The definitions of the Texture values are as follows:

Hardness (kg): the force necessary to attain a given deformation; given as the final peak of the TPA curve.

Fracturability (kg): The force at which the material fractures (there are no fracturability values for rice bread since it did not fracture).

Springiness: The rate at which a deformed samples goes back to its undeformed force is removed. This can be called Elasticity.

Cohesiveness: The quantity to simulate the strength of the internal bonds making up the body of the sample.

Gumminess: The quantity to simulate the energy required to masticate a semisolid sample to a steady state of swallowing.

Chewiness: The quantity to simulate the energy required to masticate a semi-solid sample to a steady state of swallowing.

Resilience: The ability of the sample to move to its original form.

Note: some of the above values have no units (kg) as values are obtained by multiplying and dividing various texture values and units such as kg gets cancelled.

Specific Volume was obtained by dividing volume in cc by its weight in g. The volume was determined by rape seed displacement method. The bread machine pan (if the bread was lower than the edges of pan) was covered by rape seeds and leveled by a ruler. The rape seeds in the pan were emptied into a graduated cylinder and volume determined. Similarly the volume of the empty pan was determined. The volume of the bread in the pan was the empty pan volume minus the volume of the rape seed on and around the bread. Similarly the weight of bread was determined by weighing pan containing the bread and subtracting the weight of empty pan. If the volume of bread was greater than the pan, then the bread was removed and put into a large enough container, and rape seed method described above was repeated.

| | Specific Volume | Hardness | | | | | |
|---|---|---|---|---|---|---|---|
| | (ml/g) | (kg) | Springiness | Cohesiveness | Gumminess | Chewiness | Resilence |
| Whole Rice Bread | 3.99 | 0.29 | 0.84 | 0.45 | 0.13 | 0.11 | 0.17 |
| Whole Rice Bread w/bran | 4.23 | 0.45 | 0.99 | 0.59 | 0.27 | 0.27 | 0.31 |
| Commercial White Rice Bread_{A} | 1.35 | 1.22 | 0.93 | 0.61 | 0.74 | 0.70 | 0.31 |
| Commercial Brown Rice Bread_{A} | 1.47 | 10.70 | 0.95 | 0.78 | 8.41 | 8.02 | 0.61 |
| Commercial White Rice Bread_{B} | 2.90 | 4.12 | 0.93 | 0.30 | 1.28 | 1.18 | 0.11 |
| Commercial Brown Rice Bread_{B} | 2.60 | 5.16 | 0.85 | 0.23 | 1.10 | 0.94 | 0.09 |
| Commercial Wheat White Bread_{C} | 4.23 | 0.14 | 0.97 | 0.72 | 0.10 | 0.10 | 0.31 |
| Commercial Whole Wheat Bread_{C} | 5.30 | 0.15 | 1.07 | 0.46 | 0.07 | 0.08 | 0.83 |

Commercial White Rice Bread was made from milled rice (hence white) and Commercial Brown Rice Bread was made from brown rice (partially milled—with bran). Both breads have tapioca, potato and milk solids in addition to rice flours. These breads still do not have a texture comparable to wheat breads (as indicated by the texture values in the table). Another problem is that the rice product undergo retrogradation (staleing) faster than other grain starches. The rice baked food becomes dry, hard, crumbly and quickly loses its desirable flavor.

Interpretation of Texture Values: (1) Commercial rice breads are many times harder than our whole rice bread or whole rice bread with bran, there was also a problem with retrogradation. (2) Both gumminess and chewiness TPA values were also higher than our rice breads and wheat breads indicating undesirable texture properties. (3) The commercial rice breads had hardly any flavor associated with breads—as compared with our rice breads (top two on the table) because of their retrogradation. The members of local chapter of Celiacs also confirmed our conclusion.

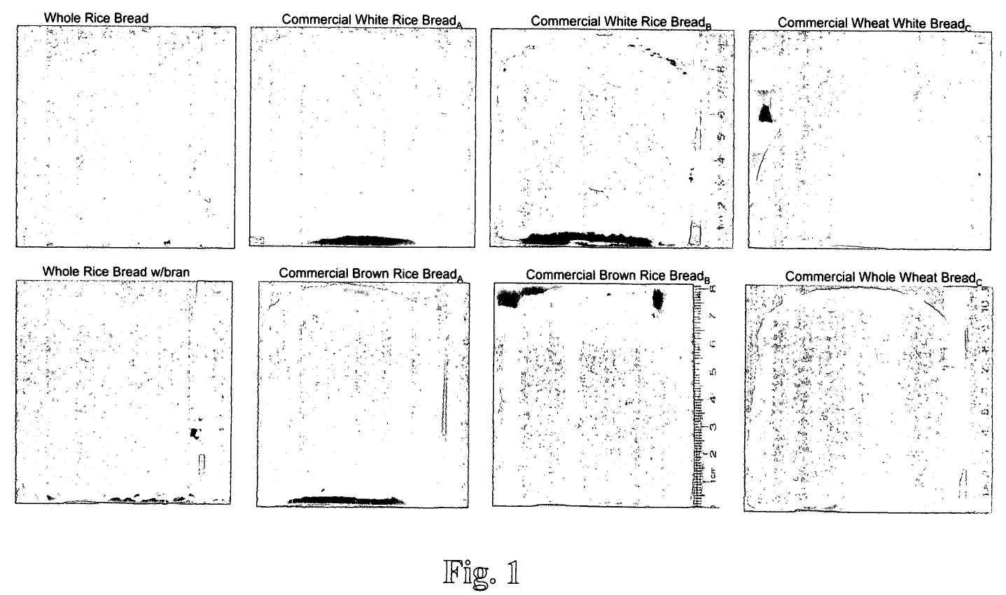

FIG. 1 shows the breads of the present invention and the commercial breads.

All of the references cited herein are incorporated by reference in their entirety. Also incorporated by reference in their entirety are the following references: Haque, A, and Morris E. R., Food Research International, 27: 379-393 (1994); Kadan, R. S., et al., J. Food Sci., 66(7): 940-944 (2001). Also incorporated by reference in their entirety are the following U.S. Pat. Nos. 6,723,340; 5,227,189; 5,458,902.

Thus, in view of the above, the present invention concerns (in part) the following:

A mix for the preparation of rice-containing baked products, comprising (or consisting essentially of or consisting of) 100% rice flour containing about 15 to about 26% amylose, about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt.

The above mix, comprising (or consisting essentially of or consisting of) 100% rice flour containing about 15 to about 26% amylose, about 0% waxy rice flour, about 2% hydroxypropyl methylcellulose food gum, about 1.5 to about 2.2% yeast, about 2 to about 7% rice bran, about 12% sugar, and about 2.6% salt.

The above mix, wherein the hydroxypropyl methylcellulose food gum is METHOCEL K4M.

The above mix, wherein the rice flour contains more than 20% amylose.

The above mix, wherein the mix is free of wheat, rye, barley, or mixtures thereof.

The above mix, wherein the mix is free of wheat.

The above mix, wherein the rice flour is produced fromshort grain rice, medium grain rice, long grain rice, or mixtures thereof.

The above mix, wherein the rice flour is produced from long grain rice.

A method for preparing a rice-containing baked product, comprising (or consisting essentially of or consisting of) mixing 100% rice flour containing about 15 to about 26% amylose, about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt with an amount of water and oil and for a time sufficient to wet all the particles, and baking.

The above method, wherein the rice-containing baked product is free of milk.

The above method, wherein the rice-containing baked product is free of egg.

The above method, wherein the hydroxypropyl methylcellulose food gum is METHOCEL K4M.

The above method, wherein the rice flour contains more than 20% amylose.

The method, comprising (or consisting essentially of or consisting of) mixing 100% rice flour containing about 15 to about 26% amylose, about 0% waxy rice flour, about 2% hydroxypropyl methylcellulose food gum, about 1.5 to about 2.2% yeast, about 2 to about 7% rice bran, about 12% sugar, and about 2.6% salt with an amount of water and oil and for a time sufficient to wet all the particles, and baking.

The above method, comprising (or consisting essentially of or consisting of) mixing 100% rice flour containing about 15 to about 26% amylose, about 0 to about 20% waxy rice flour, about 1 to about 4% hydroxypropyl methylcellulose food gum, about 1 to about 5% yeast, about 0 to about 10% rice bran, about 4 to about 20% sugar, about 1 to about 4% salt, about 2 to about 15% oil, and about 80 to about 130% water, and baking.

The above method, comprising (or consisting essentially of or consisting of) mixing 100% rice flour containing about 15 to about 26% amylose, about 0% waxy rice flour, about 2% hydroxypropyl methylcellulose food gum, about 1.5 to about 2.2% yeast, about 2 to about 7% rice bran, about 12% sugar, about 2.6% salt, about 6% oil, and about 110% water, and baking.

The above method, wherein the oil is peanut oil, canola oil, olive oil, shortening, rice bran oil, or mixtures thereof

The above method, wherein the oil is rice bran oil.

The above method, wherein the method does not involve hydrating the rice flour prior to the addition of the other ingredients.

The above method, wherein the baked product is free of wheat, rye, barley, or mixtures thereof.

The above method, wherein the baked product is free of wheat.

The above method, wherein the rice flour is produced from short grain rice, medium grain rice, long grain rice, or mixtures thereof.

The above method, wherein the rice flour is produced from long grain rice.

The above method, wherein the rice-containing baked product is bread, cakes, muffins, cupcakes, crackers, pretzels, or cookies.

The above method, wherein the rice-containing baked product is bread.

The above method, comprising (or consisting essentially of or consisting of) mixing 100% rice flour containing about 15 to about 26% amylose, about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt with an amount of water and oil and for a time sufficient to wet all the particles and produce a dough, kneading the dough, allowing the dough to rise, kneading the dough (a second time), allowing the dough to rise (a second time), mixing the dough, allowing the dough to rise (a third time), and baking the dough.

A rice-containing baked product produced by the above method.

The above rice-containing baked product, wherein the rice-containing baked product is bread, cakes, muffins, cupcakes, crackers, pretzels, or cookies.

The above rice-containing baked product, wherein the rice-containing baked product is bread.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

I claim:

1. A mix for the preparation of rice-containing baked products, comprising 100% rice flour containing about 15 to about 26% amylose, about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt.

2. The mix according to claim 1, comprising 100% rice flour containing about 15 to about 26% amylose, about 0% waxy rice flour, about 2% hydroxypropyl methylcellulose food gum, about 1.5 to about 2.2% yeast, about 2 to about 7% rice bran, about 12% sugar, and about 2.6% salt.

3. The mix according to claim 1, wherein said hydroxypropyl methylcellulose food gum is METHOCEL K4M.

4. The mix according to claim 1, wherein said rice flour contains more than 20% amylose.

5. The mix according to claim 1, wherein said mix is free of at least one member selected from the group consisting of wheat, rye, barley, and mixtures thereof.

6. The mix according to claim 1, wherein said mix is free of wheat.

7. The mix according to claim 1, wherein said rice flour is produced from at least one rice selected from the group consisting of short grain rice, medium grain rice, long grain rice, and mixtures thereof.

8. The mix according to claim 1, wherein said rice flour is produced from long grain rice.

9. A method for preparing a rice-containing baked product, said method comprising mixing 100% rice flour containing about 15 to about 26% amylose, about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt with an amount of water and oil and for a time sufficient to wet all the particles, and baking.

10. The method according to claim 9, wherein said rice-containing baked product is free of milk.

11. The method according to claim 9, wherein said rice-containing baked product is free of egg.

12. The method according to claim 9, wherein said hydroxypropyl methylcellulose food gum is METHOCEL K4M.

13. The method according to claim 9, wherein said rice flour contains more than 20% amylose.

14. The method according to claim 9, said method comprising mixing 100% rice flour containing about 15 to about 26% amylose, about 0% waxy rice flour, about 2% hydroxypropyl methylcellulose food gum, about 1.5 to about 2.2% yeast, about 2 to about 7% rice bran, about 12% sugar, and about 2.6% salt with an amount of water and oil and for a time sufficient to wet all the particles, and baking.

15. The method according to claim 9, said method comprising mixing 100% rice flour containing about 15 to about 26% amylose, about 0 to about 20% waxy rice flour, about 1 to about 4% hydroxypropyl methylcellulose food gum, about 1 to about 5% yeast, about 0 to about 10% rice bran, about 4 to about 20% sugar, about 1 to about 4% salt, about 2 to about 15% oil, and about 80 to about 130% water, and baking.

16. The method according to claim 9, said method comprising mixing 100% rice flour containing about 15 to about 26% amylose, about 0% waxy rice flour, about 2% hydroxypropyl methylcellulose food gum, about 1.5 to about 2.2% yeast, about 2 to about 7% rice bran, about 12% sugar, about 2.6% salt, about 6% oil, and about 110% water, and baking.

17. The method according to claim 9, wherein said oil is selected from the group consisting of peanut oil, canola oil, olive oil, shortening, rice bran oil, and mixtures thereof.

18. The method according to claim 9, wherein said oil is rice bran oil.

19. The method according to claim 9, wherein said method does not involve hydrating said rice flour prior to the addition of the other ingredients.

20. The method according to claim 9, wherein said baked product is free of at least one member selected from the group consisting of wheat, rye, barley, and mixtures thereof.

21. The method according to claim 9, wherein said baked product is free of wheat.

22. The method according to claim 9, wherein said rice flour is produced from at least one rice selected from the group consisting of short grain rice, medium grain rice, long grain rice, and mixtures thereof.

23. The method according to claim 9, wherein said rice flour is produced from long grain rice.

24. The method according to claim 9, wherein said rice-containing baked product is selected from the group consisting of bread, cakes, muffins, cupcakes, crackers, pretzels, and cookies.

25. The method according to claim 9, wherein said rice-containing baked product is bread.

26. The method according to claim 9, said method comprising mixing 100% rice flour containing about 15 to about 26% amylose, about 0 to about 20% waxy rice flour, about 1 to about 4% hydroxypropyl methylcellulose food gum, about 1 to about 5% yeast, about 0 to about 10% rice bran, about 4 to about 20% sugar, and about 1 to about 4% salt with an amount of water and oil and for a time sufficient to wet all the particles and produce a dough, kneading said dough, allowing said dough to rise, kneading said dough, allowing said dough to rise, mixing said dough, allowing said dough to rise, and baking said dough.

27. A rice-containing baked product produced by the method according to claim 9.

28. The rice-containing baked product according to claim 25, wherein said rice-containing baked product is selected from the group consisting of bread, cakes, muffins, cupcakes, crackers, pretzels, and cookies.

29. The rice-containing baked product according to claim 25, wherein said rice-containing baked product is bread.
